(19) United States
(12) Patent Application Publication
(10) Pub. No.: US 2021/0158088 A1
(43) Pub. Date: May 27, 2021

(54) IMAGE PROCESSING METHOD AND APPARATUS, COMPUTER DEVICE, AND COMPUTER STORAGE MEDIUM

(71) Applicant: SHENZHEN SENSETIME TECHNOLOGY CO., LTD., Shenzhen (CN)

(72) Inventors: Wenqi Shao, Shenzhen (CN); Tianjian Meng, Shenzhen (CN); Ruimao Zhang, Shenzhen (CN); Ping Luo, Shenzhen (CN); Lingyun Wu, Shenzhen (CN)

(21) Appl. No.: 17/170,149

(22) Filed: Feb. 8, 2021

Related U.S. Application Data
(63) Continuation of application No. PCT/CN2019/114721, filed on Oct. 31, 2019.

(30) Foreign Application Priority Data
Jan. 29, 2019 (CN) 201910087398.X

(51) Int. Cl. G06K 9/62; G06K 9/46; G06N 3/04; G06N 3/08

(52) U.S. Cl. CPC G06K 9/6232; G06K 9/46; G06N 3/08; G06N 3/04; G06K 9/6262

(57) ABSTRACT

An image processing method and apparatus, and a storage medium are provided. The method includes: obtaining a first feature map of an image to be processed (S101); determining a final weight vector of the first feature map (S102); determining a target normalization mode corresponding to the first feature map from a preset normalization set is determined according to the final weight vector (S103); and normalizing the first feature map by means of the target normalization mode to obtain a second feature map (S104).

### CROSS-REFERENCE TO RELATED APPLICATIONS

The present application is a continuation of International Patent Application No. PCT/CN2019/114721, filed on Oct. 31, 2019, which claims priority to Chinese Patent Application No. 201910087398.X, filed on Jan. 29, 2019. The disclosures of International Patent Application No. PCT/CN2019/114721 and Chinese Patent Application No. 201910087398.X are hereby incorporated by reference in their entireties.

### BACKGROUND

In a deep-learning-based image processing method, normalization is an indispensable module. At present, it has proposed many normalization methods for different learning tasks in the art, including Batch Normalization (BN) applied to image classification, Layer Normalization (LN) applied to sequence prediction, Instance Normalization (IN) applied to model generation and Group Normalization (GN) applied to a wider range. However, these normalization methods are only for specific models and specific tasks. For overcoming this barrier and further improving the performance of a neural network, Switchable Normalization (SN) applied to multiple visual tasks is proposed. The SN enables to get rid of dependence on a batch size by weighted combination of statistics of BN, IN and LN, and can select an optimal weighted combination of normalization operation manners for all normalization layers. However, SN still has an important defect: since SN calculates weighting coefficients for statistics in different normalization methods through changes of a normalization exponential function (softmax), the weighting coefficients are equal to 0. This means all the normalization layers for SN are required to calculate statistics of multiple normalization operations at any moment, namely each normalization corresponds to more than one normalization manner, resulting in redundant calculation.

### SUMMARY

The disclosure relates to the field of computer vision communication, and particularly relates to, but not limited to an image processing method and device, a computer device and a storage medium.

A first aspect of the embodiments of the disclosure provides an image processing method, which may include the following operations. A first feature map of an image to be processed is acquired. A final weight vector of the first feature map is determined. A target normalization manner corresponding to the first feature map in a preset normalization set is determined according to the final weight vector. Normalization processing is performed on the first feature map in the target normalization manner to obtain a second feature map.

A second aspect of the embodiments of the disclosure provides an image processing apparatus, which includes a processor and a memory for storing instructions executable by the processor. The processor is configured to perform the operations of the image processing method in the first aspect.

A third aspect of the embodiments of the disclosure provides a storage medium, having stored therein computer instructions that, when being executed by a processor, causes the processor to implement the operations of the image processing method in the first aspect.

### BRIEF DESCRIPTION OF THE DRAWINGS

FIG. 1A is a composition structure diagram of a network architecture according to an embodiment of the present disclosure.

FIG. 1B is an implementation flowchart of an image processing method according to an embodiment of the present disclosure.

FIG. 2A is an implementation flowchart of an image processing method according to an embodiment of the present disclosure.

FIG. 2B is another implementation flowchart of an image processing method according to an embodiment of the present disclosure.

FIG. 2C is another implementation flowchart of an image processing method according to an embodiment of the present disclosure.

FIG. 3 is a schematic diagram of a comparison result of weight vectors obtained by different functions.

FIG. 4 is a schematic diagram of weight vectors obtained based on different functions and different parameters according to an embodiment of the disclosure.

FIG. 5 is a composition structure diagram of an image processing device according to an embodiment of the disclosure.

FIG. 6 is a composition structure diagram of a computer device according to an embodiment of the disclosure.

### DETAILED DESCRIPTION

In order to make the purposes, technical solutions and advantages of the embodiments of the disclosure clearer, specific technical solutions of the disclosure will further be described in detail below in combination with the drawings in the embodiments of the disclosure. The following embodiments are adopted to describe the disclosure but not intended to limit the scope of the disclosure.

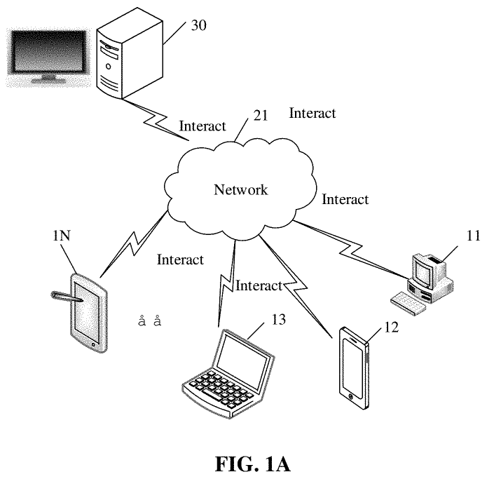

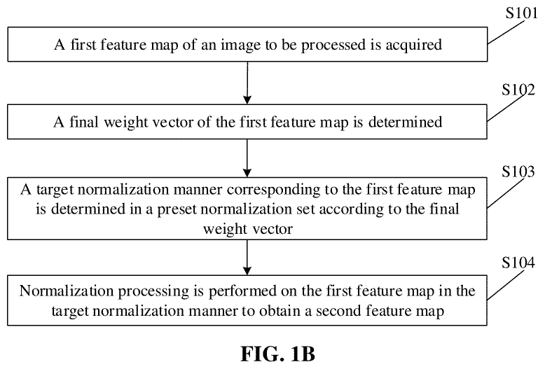

First of all, the embodiments provide a network architecture. FIG. 1A is a composition structure diagram of a network architecture according to an embodiment of the disclosure. As shown in FIG. 1A, the network architecture includes two or more computer devices 11 to 1N and a server 30. The computer devices 11 to 1N interact with the server 31 through a network 21. The computer device may be various types of computer devices with information processing capability during implementation. For example, the computer device may include a mobile phone, a tablet computer, a desktop computer and a personal digital assistant, etc.

The embodiments provide an image processing method, which enables to select the most suitable normalization manner for each normalization layer of a neural network, so that a generalization ability of the neural network is improved, and the testing process is accelerated. The method is applied to a computer device, and functions realized by the method may be realized by calling a program code through a processor in the computer device. Of course, the program code may be stored in a computer storage medium. It can be seen that the computer device at least includes the processor and the storage medium.

FIG. 1B is an implementation flowchart of an image processing method according to an embodiment of the disclosure. As shown in FIG. 1B, the method includes the following steps.

In S101, a first feature map of an image to be processed is acquired. Herein, the image to be processed may be an image with a complex appearance, or may also be an image with a simple appearance. The operation S101 may be implemented by a computer device. Furthermore, the computer device may be an intelligent terminal. For example, it may be a mobile terminal device with a wireless communication capability such as a mobile phone (for example, a cellphone), a tablet computer and a notebook computer, or may also be an immobile intelligent terminal device such as a desktop computer. The computer device is configured for image recognition or processing. The first feature map may be a first feature map obtained by performing feature extraction on the image to be processed by use of a convolutional layer in a neural network.

In S102, a final weight vector of the first feature map is determined. Herein, the final weight vector of the first feature map may be calculated according to a preset parameter set, thereby determining the final weight vector of the first feature map. The preset parameter set includes a first hyper-parameter, a second hyper-parameter and a learning parameter. The first hyper-parameter u is configured to represent a center of a preset simplex, the second hyper-parameter r is configured to reduce a value range of the final weight vector, and a value range of the second hyper-parameter r is greater than 0 and less than or equal to a distance from a center to vertex of the preset simplex. In the embodiment, a dimension of the learning parameter, a dimension of the first hyper-parameter and a value of the first hyper-parameter in each dimension are determined according to the number of normalization manners in a preset normalization set, where a sum of the values of the first hyper-parameter in each dimension is 1, the dimension of the first hyper-parameter is the same as the dimension of the learning parameter, the first hyper-parameter has the same the value in each dimension and the sum of the values in each dimension is 1. Then, a distance from the center to vertex of the preset simplex is determined, and the distance is determined as a preset threshold corresponding to the second hyper-parameter, where the preset simplex has a preset fixed value in each edge and the number of vertexes thereof is the same as the number of the normalization manners, and the second hyper-parameter has a value greater than 0 and less than or equal to the preset threshold. For example, if the preset normalization set includes three normalization manners (for example, BN, IN and LN), the preset simplex is a regular triangle having a side length of root (2). The learning parameter z is any three-dimensional vector, for example, z (0.5, 0.3, 0.2). The first hyper-parameter is a three-dimensional vector u (⅓, ⅓, ⅓). It can be seen that the second hyper-parameter is a radius of a circle originating from the center of the simplex and gradually enlarged along a training process, namely the second hyper-parameter is greater than 0 and less than the distance from the center to vertex of the simplex. The preset normalization set includes multiple normalization manners, for example, the preset normalization set Ω includes BN, IN and LN and may be represented as Ω={BN, IN, LN}. The operation S102 may be implemented as follows. The final weight vector of the first feature map is calculated at first according to the first hyper-parameter, second hyper-parameter and learning parameter in the preset parameter set. Since an SSN manner is adopted, then for each feature map, a normalization manner suitable for the feature map, rather than a weighted combination of multiple normalization manners, is selected in a completely sparse manner, so that redundant calculation is avoided, and generalization ability of the neural network is improved.

In S103, a target normalization manner corresponding to the first feature map is determined in a preset normalization set according to the final weight vector. Herein, the final weight vector may be understood as a completely sparse weight vector, namely a value of the weight vector only in one dimension is 1, and values in the remaining dimensions are 0. The operation S103 may be understood as follows: if the preset normalization set is Ω={BN, IN, LN}, when the final weight vector p is (0, 0, 1), it is indicated that the target normalization manner is LN; when the final weight vector p is (0, 1, 0), it is indicated that the target normalization manner is IN; and when the final weight vector p is (1, 0, 0), it is indicated that the target normalization manner is BN.

In S104, normalization processing is performed on the first feature map in the target normalization manner to obtain a second feature map. Herein, the second feature map is a feature map obtained by performing normalization processing on the first feature map in the target normalization manner. It can be understood that, in the embodiment, the image is processed in the SSN manner through the abovementioned processing steps, so that a suitable normalization manner is selected more efficiently to process the image. The obtained second feature map may be used for processing steps in subsequent deep learning.

In the embodiment of the disclosure, SSN is applied to the neural network, and then the final weight vector is determined based on the preset parameter set, thereby determining the target normalization manner. In such a manner, for each feature map, a normalization manner applicable to the present feature map, rather than a weighted combination of multiple types of normalization, is adaptively selected, so that redundant calculation is avoided, and generalization ability of the neural network is improved.

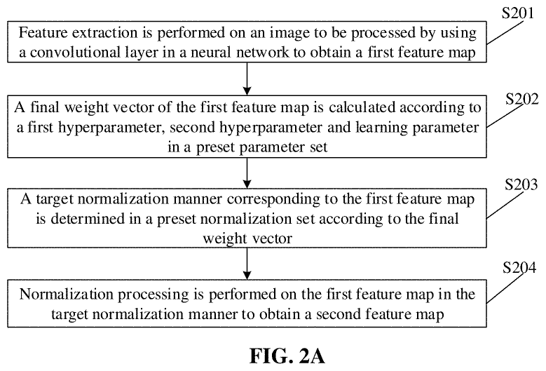

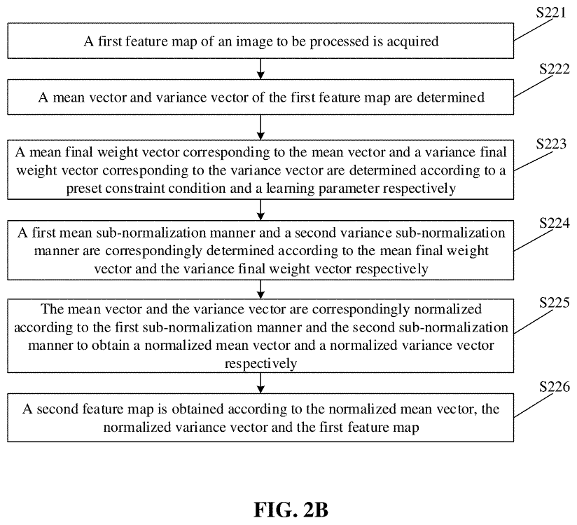

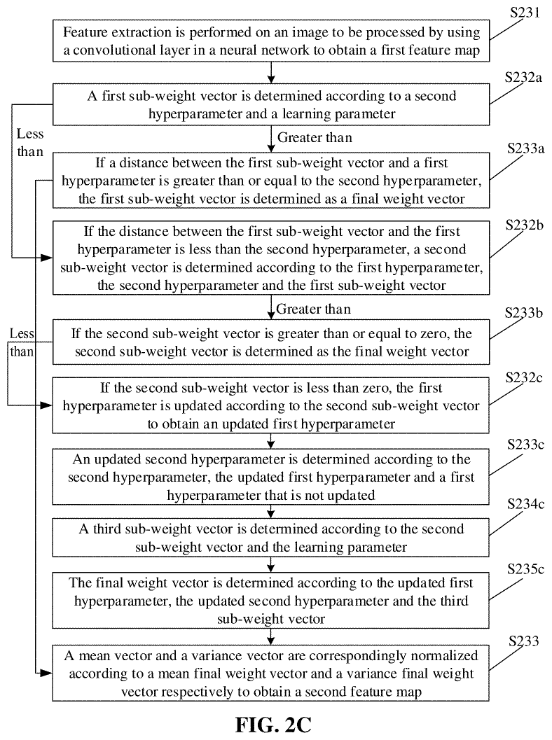

An embodiment provides an image processing method. FIG. 2A is an implementation flowchart of an image processing method according to an embodiment of the disclosure. As shown in FIG. 2A, the method includes the following steps.

In S201, feature extraction is performed on an image to be processed by use of a convolutional layer in a neural network to obtain a first feature map. Specifically, the image to be processed is input to the neural network, and feature extraction is performed on a sample image through the convolutional layer to obtain the first feature map.

In S202, a final weight vector of the first feature map is calculated according to a first hyper-parameter, second hyper-parameter and learning parameter in a preset parameter set. Specifically, the operation S202 may be implemented as follows. First, a preset constraint condition is determined according to the first hyper-parameter and the second hyper-parameter. Herein, the preset constraint condition is that a distance between the final weight vector and the first hyper-parameter is limited to be greater than or equal to a value of the second hyper-parameter, and may be represented as that the final weight vector p meets ∥p−u∥₂≥r. Then, the final weight vector of the first feature map is determined according to the preset constraint condition and the learning parameter. Finally, the first feature map is normalized according to the final weight vector to obtain a second feature map. In this way, the final weight vector obtained based on the preset constraint condition and the learning parameter is completely sparse during training.

In S203, a target normalization manner corresponding to the first feature map in a preset normalization set is determined according to the final weight vector.

In S204, normalization processing is performed on the first feature map in the target normalization manner to obtain a second feature map.

In the embodiment, the neural network is trained based on the input learning parameter z and the constraint condition, so that the final weight vector of the obtained feature map is completely sparse. As a result, for the image to be processed input to the neural network, the normalization manner suitable for the feature map can be adaptively selected to normalize the feature map, so that redundant calculation is avoided, and generalization ability of the neural network is improved.

An embodiment provides an image processing method. FIG. 2B is another implementation flowchart of an image processing method according to an embodiment of the disclosure. As shown in FIG. 2B, the method includes the following steps.

In S221, a first feature map of an image to be processed is acquired.

In S222, a mean vector and variance vector of the first feature map are determined. Specifically, the mean vector and variance vector of the first feature map are determined based on a preset normalization set. Both a dimension of the mean vector and a dimension of the variance vector are the same as the number of normalization manners in the preset normalization set. A mean of the mean vector in the i-th dimension corresponds to the j-th normalization manner in the preset normalization set, and a variance of the variance vector in the i-th dimension corresponds to the j-th normalization manner in the preset normalization set, i and j being integers greater than 0 and less than or equal to the number of the normalization manners in the preset normalization set. For example, the preset normalization set is Ω={BN, IN, LN}, the mean value and variance vector of the first feature map are determined based on the normalization set, where both the mean vector and the variance vector are three-dimensional vectors, a mean of the mean vector in the first dimension corresponds to IN, a mean in the second dimension corresponds to BN, and a mean in the third dimension corresponds to LN.

In S223, a mean final weight vector corresponding to the mean vector and a variance final weight vector corresponding to the variance vector are determined according to a preset constraint condition and a learning parameter respectively. The operations S222 and S223 provide a manner for implementing the operation that “a final weight vector of the first feature map is determined”. In this manner, a preset condition is preset so that the final weight vector obtained is a completely sparse weight vector, namely a value of in the weight vector in only one dimension is 1 and values in the remaining dimensions are 0.

In S224, a first mean sub-normalization manner and a second variance sub-normalization manner are correspondingly determined according to the mean final weight vector and the variance final weight vector respectively. Herein, the first sub-normalization manner and the second sub-normalization manner are the same or different. For example, if the preset normalization set is Ω={BN, IN, LN}, when the mean final weight vector is (0, 0, 1), the first mean sub-normalization manner is LN, and when the variance final weight vector is (0, 1, 0), the second variance sub-normalization manner is IN.

In S225, the mean vector and the variance vector are correspondingly normalized according to the first sub-normalization manner and the second sub-normalization manner to obtain a normalized mean vector and a normalized variance vector respectively. For example, if the mean final weight vector is (0, 0, 1), namely the first mean sub-normalization manner is LN, normalization processing is performed on the mean vector by LN to obtain the normalized mean vector. If the variance final weight vector is (0, 1, 0), namely the second variance sub-normalization manner is IN, normalization processing is performed on the variance vector by IN to obtain the normalized variance vector.

In S226, a second feature map is obtained according to the normalized mean vector, the normalized variance vector and the first feature map. Specifically, the operation S226 may be implemented as follows. First, a weight of the mean final weight vector in each dimension and a weight of the mean vector in each dimension are multiplied in a one-to-one correspondence, and products obtained in each dimension are added to obtain the normalized mean vector. Then, a weight of the variance final weight vector in each dimension and a variance of the variance vector in each dimension are multiplied in a one-to-one correspondence, and products obtained in each dimension are added to obtain the normalized variance vector. Finally, the second feature map is obtained according to the normalized mean vector and the normalized variance vector.

The operations S225 and S226 provide a manner for implementing the operation that “normalization processing is performed on the first feature map in a target normalization manner to obtain the second feature map”. In this manner, the first sub-normalization manner and second sub-normalization manner corresponding to the mean vector and the variance vector respectively are obtained to normalize the mean vector and the variance vector, so that generalization ability of a neural network is enhanced.

In the embodiment of the disclosure, the final weight vectors corresponding to the mean vector and the variance vector respectively are obtained based on the preset constraint condition and the learning parameter, so that the final weight vector is completely sparse; and the first feature map is normalized based on the final weight vector to obtain the second feature map, so that the neural network can adaptively select a normalization manner for the image to be processed, and thus the calculation burden is reduced.

An embodiment provides an image processing method. FIG. 2C is another implementation flowchart of an image processing method according to an embodiment of the disclosure. As shown in FIG. 2C, the method includes the following steps.

In S231, feature extraction is performed on an image to be processed by use of a convolutional layer in a neural network to obtain a first feature map.

In S232a, a first sub-weight vector is determined according to a second hyper-parameter and a learning parameter. If a distance between the first sub-weight vector and a first hyper-parameter u is greater than or equal to the second hyper-parameter r, namely ∥p₀−u∥₂≥r, S233a is executed, or otherwise S232b is executed.

In S233a, if a distance between the first sub-weight vector and a first hyper-parameter is greater than or equal to the second hyper-parameter, the first sub-weight vector is determined as a final weight vector. Following the operation S233a, S232b is executed. The operations S232a and S233a provide a manner for “determining the final weight vector”, namely the first sub-weight vector is the final weight vector responsive to determining that the first sub-weight vector meets a preset constraint condition.

In S232b, if the distance between the first sub-weight vector and the first hyper-parameter is less than the second hyper-parameter, a second sub-weight vector is determined according to the first hyper-parameter, the second hyper-parameter and the first sub-weight vector. Since the second hyper-parameter has a value greater than 0 and less than a distance from a center to vertex of a preset simplex, for the second hyper-parameter, research personnel may autonomously set the second hyper-parameter to be any value from 0 to the distance from the center to vertex of the preset simplex during training of the neural network. Moreover, in the embodiment, if the second hyper-parameter is closer to the distance from the center to vertex of the preset simplex, the weight vector is sparser. Herein, if the second sub-weight vector Pt is greater than or equal to 0, S233b is executed, or otherwise S232c is executed.

In S233b, if the second sub-weight vector is greater than or equal to 0, the second sub-weight vector is determined as the final weight vector. Herein, following the S233b, S232c is executed. The operations S232b and S233b provide another manner for “determining the final weight vector”, namely the second sub-weight vector is calculated according to the first hyper-parameter, the second hyper-parameter and the first sub-weight vector responsive to determining that the first sub-weight vector does not meet the preset constraint condition; and if the second sub-weight vector is greater than 0, the second sub-weight vector is determined as the final weight vector.

In S232c, if the second sub-weight vector is less than zero, the first hyper-parameter is updated according to the second sub-weight vector to obtain an updated first hyper-parameter. For example, the first hyper-parameter is

$${u}^{′} = max \{ \frac{( {p}_{1} ) i}{2} , 0 \} , i = 1 , 2 , 3 ,$$

where i=1, 2, 3 corresponds to the normalization manners BN, IN and LN respectively.

In S233c, an updated second hyper-parameter is determined according to the second hyper-parameter, the updated first hyper-parameter and a first hyper-parameter that is not updated. The updated second hyper-parameter r′ may be represented as r′=\sqrt{r²−∥u−u′∥₂²}.

In S234c, a third sub-weight vector is determined according to the second sub-weight vector and the learning parameter. Herein, the second sub-weight vector is mapped to a sparsemax function to obtain the third sub-weight vector P₂, namely p₂=sparsemax(p₁).

In S235c, the final weight vector is determined according to the updated first hyper-parameter, the updated second hyper-parameter and the third sub-weight vector. Herein, the final weight vector p may be represented as

$$p = {r}^{′} \frac{{p}_{2} - {u}^{′}}{{‖ {p}_{2} - {u}^{′} ‖}_{2}} + {u}^{′} .$$

Determining the final weight vector may refer to determining a mean final weight vector corresponding to a mean vector and a variance final weight vector corresponding to a variance vector according to the learning parameter and the preset constraint condition that is determined according to the first hyper-parameter and the second hyper-parameter.

The operations S232c and S234c provide another manner for “determining the final weight vector”, namely, responsive to determining that the second sub-weight vector is less than 0, the input learning parameter is updated again to acquire the third sub-weight vector, and then the final weight vector is obtained based on the third sub-weight vector.

In S233, the mean vector and the variance vector are correspondingly normalized according to the mean final weight vector and the variance final weight vector respectively to obtain a second feature map. Specifically, S233 may be implemented as follows. First, a weight of the mean final weight vector in each dimension and a weight of the mean vector in each dimension are correspondingly multiplied in a one-to-one correspondence, and products obtained in each dimension are summed to obtain a normalized mean vector. Then, a weight of the variance final weight vector in each dimension and a variance of the variance vector in each dimension are correspondingly multiplied in a one-to-one correspondence to obtain a product in each dimension, and products obtained in each dimension are summed to obtain a normalized variance vector. Finally, a difference between the first feature map and the normalized mean vector is determined, a mean variance corresponding to a sum of the normalized variance vector and a preset adjustment amount is determined, a ratio of the difference to the mean variance is determined, and the ratio is adjusted according to a preset scaling parameter and a preset shift parameter to obtain the second feature map.

In the embodiment, multiple determinations are made based on the first learning parameter and the preset constraint condition so that the final weight vector is completely sparse, and the first feature map is normalized based on the final weight vector to obtain the second feature map, so that fewer parameters are involved in the normalization manner and generalization ability of a deep neural network is enhanced.

In the embodiments of the disclosure, a completely sparse function (sparsestmax) is proposed to replace a softmax function in SN, and a sparse optimization problem is converted to forward calculation of a neural network, so that the weighting coefficient is completely sparse, and thus the most suitable normalization operations, rather than weighted combinations of normalization operation manners, can be selected for all normalization layers. In the embodiments, an expression of SSN is specified as formula (1):

$${\hat{h}}_{n c i j} = γ \frac{{h}_{n c i j} - {\sum }_{k ∈ Ω} {p}_{k} {μ}_{k}}{\sqrt{{\sum }_{k ∈ Ω} {p}_{k}^{′} {σ}_{k}^{2} + {o}^{`}}} + β$$

where pₖ represents a weight corresponding to a mean vector of an input feature map, p′ₖ represents a weight corresponding to a variance vector of the feature map,

$${\sum }_{k = 1}^{\vert Ω \vert} {p}_{k} = 1 , {\sum }_{k = 1}^{\vert Ω \vert} {p}_{k}^{′} = 1 , ∀ {p}_{k} , {p}_{k}^{′} ∈ \{ 0 , 1 \} ;$$

h_{ncij} and ĥ_{ncij} represent feature maps before normalization and after normalization, n∈[1, N] N represents the number of samples in a small batch, C∈[1, C], C is the number of channels of the feature map, i∈[1, H], H is a height of each channel in a space dimension, j∈[1, W], W is a weight of each channel in the space dimension, γ and β are conventional scaling and shift parameters respectively, and ε is a preset adjustment amount (which is a very small amount) for preventing instability of the numerical value. For each pixel, the normalized mean is

$$μ = {\sum }_{k ∈ Ω} {p}_{k} {μ}_{k} ,$$

and the normalized variance is

$${σ}^{2} = {\sum }_{k ∈ Ω} {p}_{k}^{′} {σ}_{2}^{2} .$$

In SSN, pₖ and p′ₖ are limited to be variables of 0 or 1. In this case, only one of three values p_{bn}, pᵢₙ and pₗₙ in the weight vector p=(pᵢₙ, p_{bn}, pₗₙ) is 1, and the others are 0. Ω={IN, BN, LN} represents the preset normalization set. μₖ and δₖ² are the mean and variance, corresponding to the normalization manners IN, BN and LN, of the feature map respectively, where k∈{1, 2, 3} corresponds to different normalization manners, namely when k takes a value of 1, μₖ and δₖ² are the mean and variance that are obtained in the normalization manner IN respectively; when k takes a value of 2, μₖ and δₖ² are the mean and variance that are obtained in the normalization manner BN respectively; and when k takes a value of 3, μₖ and δₖ² are the mean and variance that are obtained in the normalization manner LN respectively. In the embodiment, a weight vector corresponding to the mean of the feature map is represented as p=(p₁, p₂, p₃), and a weight vector corresponding to the variance of the feature map is represented as p′=(p′₁, p′₂, p′₃).

In the formula (1),

$${μ}_{k} = \frac{1}{\vert {I}_{k} \vert} {\sum }_{( n , c , i , j ) ∈ {I}_{k}} {h}_{n c i j} , {σ}_{k}^{2} = \frac{1}{\vert {I}_{k} \vert} {\sum }_{( n c i j ) ∈ {I}_{k}} {( {h}_{n c i j} - {μ}_{k} )}^{2} ,$$

Iₖ represents a pixel range statistically calculated in different normalization manners in the normalization set, h_{ncij} is considered as a pixel within Iₖ, and pixel ranges corresponding to the normalization manners BN, IN and LN are represented as I_{bn}, Iᵢₙ and Iₗₙ respectively.

I_{bn}={(n,i,j)|n∈[1,N],i∈[1,H],j∈[1×W]}

Iᵢₙ={(i,j)|i∈[1,H],j∈[1×W]}

Iₗₙ={(c,i,j)|c∈[1,C],i∈[1,H],j∈[1×W]} (2);

According to the formula (1), SSN selects a single normalization manner from the normalization set, and if a sparse constraint ∀pₖ, p′ₖ∈{0,1} is relaxed to a soft constraint ∀pₖ, p′ₖ∈(0,1), sparsification capability of SSN is reduced.

In the embodiment, p=ƒ(z) is set as a function to learn the weight vector p in SSN, where Z=(z_{bn}, zᵢₙ, zₗₙ), Z_{bn}, Zᵢₙ and Zₗₙ are network parameters corresponding to statistics of three dimensions, which can be optimized and learned using back propagation. Before presenting its formulation, four requirements of p=ƒ(z) are introduced in order to make SSN effective and easy to use as much as possible.

(1) Unit length. The weight vector p is in unit length. The l₁ norm of p is 1, and for all pₖ>0.

(2) Completely sparse. The weight vector p is completely sparse. In other words, the function p=ƒ(z) is required to return a one-hot vector where only one weight is 1 and others are 0.

(3) Easy to use. SSN can be implemented as a module and easily plugged to any network and task. For achieving this, all constraints of the weight vector p have to be met and implemented in forward calculation of the network. This is different from adding l₀ or l₁ penalty to a loss function, making model development cumbersome because coefficients of theses penalties are often sensitive to batch sizes, network architectures and tasks.

(4) Stability. The optimization of the weight vector p should be stable, which means that p=ƒ(z) should be capable to maintain sparsity in the training phase. For example, training is difficult if p=ƒ(z) returns a normalized value in the present step and another normalized value in the next step.

Functions related to p=ƒ(z) are softmax (z) and sparsemax (z), but they do not meet all the above four requirements. Firstly, softmax(z) is employed in related art. However, its parameter z always have full support, that is, Pₖ≠0, which means the normalization manner is not sparse when the function softmax(z) is employed. Secondly, another function is sparsemax (z) that extends softmax(z) to generate a partially sparse distribution. Sparsemax (z) projecting z to its closest point p on a (K−1)-dimensional simplex by minimizing the Euclidean distance between p and z, as shown in formula (3):

$$sparsemax ( z ) := {argmin}_{p ∈ {Δ}^{K - 1}} {‖ p - 1 ‖}_{2}^{2} ; \qquad ( 3 )$$

where Δ^{K-1} represents a (K−1)-dimensional simplex that is a convex polyhedron containing K vertexes. For example, when K is 3, Δ² represents a two-dimensional simplex that is a regular triangle. Vertexes of the regular triangle correspond to BN, IN and LN respectively.

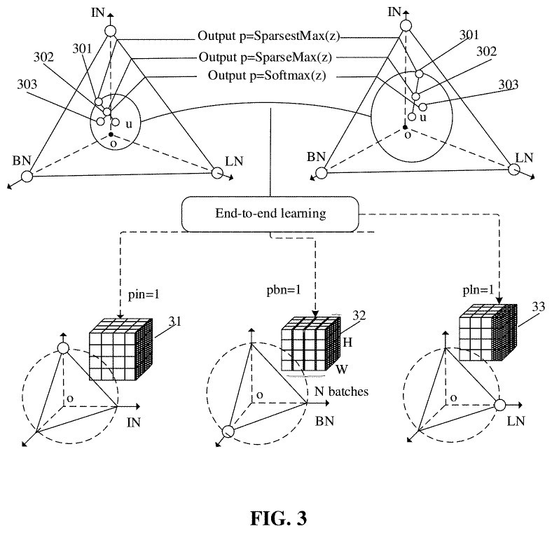

FIG. 3 is a result diagram of weight vectors obtained by different functions. As shown in FIG. 3, the point O represents an origin of a three-dimensional coordinate system, the point 301 represents a weight vector output by the function sparsestmax (z), the point 303 represents a weight vector output by the function sparsemax (z), the point 303 represents a weight vector output by the function softmax (z), the regular triangle represents a two-dimensional simplex embedded into the three-dimensional coordinate system, and u is a center of the simplex. The cube 31 represents a feature map corresponding to the normalization manner IN and whose dimension is N×C×H×W, namely a pixel range Iᵢₙ of pixels is calculated along a batch axis N. The cube 32 represents a feature map corresponding to the normalization manner BN and whose dimension is N×C×H×W, namely a pixel range I_{bn} of pixels is calculated along a spatial axis H×W. The cube 33 represents a feature map corresponding to the normalization manner LN and whose dimension is N×C×H×W, namely a pixel range Iₗₙ of pixels is calculated along a channel axis C. Each vertex of the regular triangle represents one of the three normalization manners. As shown in FIG. 3, the weight vector output by the softmax function is closer to the center u of the simplex than the weight vectors output by the sparsemax and sparsestmax functions. Through the sparsestmax function disclosed in the embodiments of the disclosure, the final weight vector converges to one of the vertexes of the simplex in an end-to-end manner, and only one normalization manner is selected from the three normalization methods to normalize the feature map. In other words, the weight vector p generated by the sparsemax function is closer to a boundary of the simplex than the weight vector p generated by the softmax function, and it is indicated that the sparsemax function generates a higher sparse ratio than the softmax function. For example, if a learning parameter z=(0.8, 0.6, 0.1), softmax (z)=(0.43, 0.35, 0.22) while sparsemax (z)=(0.6, 0.4, 0), which indicates that, through the sparsemax function, some elements of p may be 0, but the ratio that the weight vector is completely sparse cannot be ensured because each point on the simplex may be a solution to the formula (3).

For meeting all the constraints as discussed above, it is introduced in the embodiments of the disclosure a sparsestmax function, which is a novel sparse version of the softmax function. The sparsestmax function may be defined as formula (4):

$$SparsestMax ( z ; r ) := {argmin}_{p ∈ {Δ}_{r}^{K - 1}} {‖ p - z ‖}_{2}^{2} ; \qquad ( 4 )$$

where Δᵣ^{K-1}:={p∈R^{K}|1^{T} p=1, ∥p−u∥₂≥r, p≥0} is a simplex with a circle constraint 1^{T} p=1, ∥p−u∥₂≥r. Herein, the vector

$$u = \frac{1}{K} 1$$

is a center of the simplex (i.e., a first hyper-parameter), 1 represents an all-1 vector, r is a radius of a circle, and a center of the circle is the center of the simplex.

Compared with the sparsemax function, the sparsestmax function introduces a circular constraint 1^{T} p=1, ∥p−u∥₂≥r that has an intuitively geometric meaning. Unlike the solution space of the sparsemax function (where the solution space is Δ^{K-1}), a solution space of sparsestmax is a circle with center u and radius r excluded from a simplex.

For meeting the requirement of completely sparse requirement, the radius r (i.e., a second hyper-parameter) is linearly increased from 0 to r_{c} in the training phase. r_{c} is a radius of a circumcircle of the simplex. When r=r_{c}, the solution space of the formula (4) only includes K vertexes of the simplex such that the sparsestmax function is completely sparse.

In the embodiments, a sparsestmax-function-based SSN process may be summarized as the following steps. In a first step, a first sub-weight vector p₀ is determined according to the learning parameter z, the first hyper-parameter u and the second hyper-parameter r. In a second step, if ∥p−u∥₂≥r a final weight vector is p=p₀ and a fourth step is executed, or otherwise a second sub-weight vector p₁ is calculated, namely

$${p}_{1} = r \frac{{p}_{0} - u}{{‖ {p}_{0} - u ‖}_{2}} + u .$$

In a third step, if p₁≥0, the final weight vector is p=p₁ and the fourth step is executed, or otherwise an updated first hyper-parameter u, an updated second hyper-parameter r and a third sub-weight vector p₂ are acquired and the final weight vector

$${p}_{1} = {r}^{′} \frac{{p}_{2} - {u}^{′}}{{‖ {p}_{0} - {u}^{′} ‖}_{2}} + {u}^{′}$$

is determined, where

$${u}^{′} = max \{ \frac{( {p}_{1} ) i}{2} , 0 \} , i = 1 , 2 , 3 ,$$

r′=\sqrt{r²−∥u−u′∥₂²} and p₂=sparsemax(p₁). In the fourth step, it is determined that a mean of the feature map is

$$µ = {\sum }_{k ∈ Ω} {p}_{k} {μ}_{k}$$

and a variance is

$${σ}^{2} = {\sum }_{k ∈ Ω} {p}_{k}^{′} {σ}_{k}^{2} ,$$

where p′ is a final weight vector corresponding to the variance. A manner for acquiring the final weight vector corresponding to the variance and a manner for acquiring a final weight vector corresponding to the mean are the same.

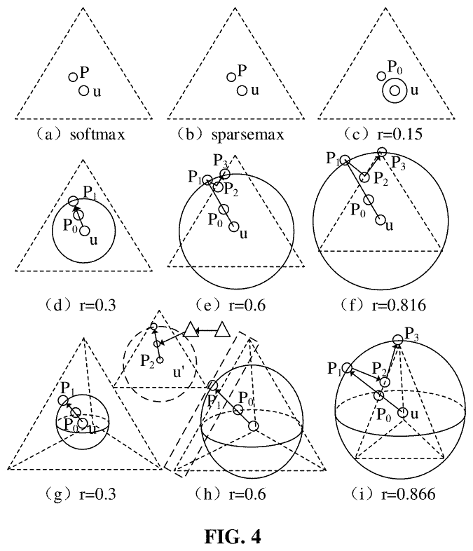

FIG. 4 is a schematic diagram of obtaining weight vectors based on different functions and different parameters according to an embodiment of the disclosure. FIG. 4(a) represents a weight vector p=(0.39, 0.32, 0.29) obtained by the softmax function in the case of K=3 and z=(0.5, 0.3, 0.2). FIG. 4(b) represents a weight vector p=(0.5, 0.3, 0.2) obtained by the sparsemax function in the case of K=3 and z=(0.5, 0.3, 0.2). It can be seen that an output of the softmax function is more uniform than an output of the sparsemax function. FIG. 4(c) to FIG. 4(f) represent weight vectors obtained based on different radii (i.e., different second hyper-parameters) when K=3. The sparsestmax function generates an increasingly sparse output with gradually increasing r in training.

As shown in FIG. 4(b) and FIG. 4(c), given z=(0.5, 0.3, 0.2), and the weight vector output by the sparsemax function is p₀=(0.5, 0.3, 0.2). When r=0.15, p₀ meets the constraint ∥p−u∥₂≥r. Therefore, p₀ is also a solution to the sparsestmax function. In such case, a calculation method of sparsestmax is the same as that of sparsemax to return an optimal weight vector.

As shown in FIG. 4(d), when r increases to 0.3 and thus ∥p−u∥₂≥r when p₀=(0.5, 0.3, 0.2), it implies that the preset constraint condition is not met. In such case, sparsestmax returns to the point p₁ on the circle, which is calculated by projecting p₀ to a plane of the circle, namely

$${p}_{1} = r \frac{{p}_{0} - u}{{‖ {p}_{0} - u ‖}_{2}} + u = ( 0.56 , 0.39 , 0.15 )$$

as the output.

As shown in FIG. 4(e), when r=0.6, p₁ moves out of the simplex. In this case, p₁ is projected back to the closest point on the simplex, i.e., p₂, which is then then pushed to p₃ by the sparsestmax function using an expression of p₃, as shown in the formula (5):

$${p}_{3} = {r}^{′} \frac{{p}_{2} - {u}^{′}}{{‖ {p}_{2} - {u}^{′} ‖}_{2}} + {u}^{′} \qquad ( 5 )$$

As shown in FIG. 4(f), when r=rc=0.816, for K=3, the circle becomes a circumcircle of the simplex, and p₃ moves to one of the three vertexes, which is a point closest to p₀. In such case, the completely sparse final weight vector p₃=(1, 0, 0) is as the output.

The sparsestmax function meets all the four requirements of p=ƒ(z) discussed before. Since the radius r increases from 0 to r_{c} along with training, the solution space of the weight vector output by the sparsestmax function is reduced to the three vertexes of the simplex, and it is indicated that the weight vector p output by the sparsestmax function is a unit length and is completely sparse, namely the first two requirements of p=ƒ(z) are met. For the third requirement, the sparsestmax function is executed in forward calculation of the deep network, instead of introducing an additional sparse regularization term to the loss function, which avoids the case of difficulty to adjust the regularization intensity, and thus is easy to use. For the fourth requirement, SSN may be trained stably by the sparsestmax function, so that the fourth requirement is met. In general, once pₖ=SparsestMaxₖ (z; r)=0 for each k, zₖ is zero. This property reveals that an element of p, once being 0, will not “wake up” in the subsequent training phase, which is favorable for maintaining sparsity in training.

As described above, the above property of different stages are checked. Herein, (p−u) and ∥p−u∥₂ represent a “parsing direction” and a “parsing distance” respectively. If pₖ=0, it is indicated that the k-th component in p is less important than others. Therefore, stop training pₖ is reasonable. pₖ=0 occurs when p₀ moves to p₁ and then to p₂. In this case, it is indicated that p₁ has learned a good sparse direction before it moves out of the simplex.

In the embodiments, the importance ratios in SN do not need to learn the sparse distance. They focus on updating the sparse direction to regulate relative magnitudes of IN, BN and LN in each training step. This property intuitively reduces the difficulty when training the importance ratios. Let L be the total number of normalization layers of a deep network. In training phase, computational complexity is relatively low. However, SSN learns a completely sparse selection of normalization manner, making it faster than that in the related art in a testing stage. Unlike SN that needs to estimate statistics of IN, BN and LN in each normalization layer, SSN computes statistics for only one normalization manner. In such case, BN in SSN can be turned into a linear transformation and then merge it to the previous convolution layer, so that the generalization ability of the network is improved and the testing process is accelerated, and moreover, generalization in the deep neural network is enhanced.

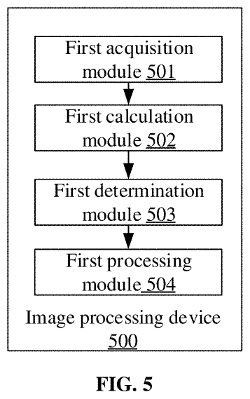

The embodiments of the disclosure provide an image processing device. FIG. 5 is a composition structure diagram of an image processing device according to an embodiment of the disclosure. As shown in FIG. 5, the device 500 includes a first acquisition module 501, a first calculation module 502, a first determination module 503 and a first processing module 504. The first acquisition module 501 is configured to acquire a first feature map of an image to be processed. The first calculation module 502 is configured to determine a final weight vector of the first feature map. The first determination module 503 is configured to determine a target normalization manner corresponding to the first feature map in a preset normalization set according to the final weight vector. The first processing module 504 is configured to perform normalization processing on the first feature map in the target normalization manner to obtain a second feature map.

In the embodiment of the disclosure, the first acquisition module 501 includes a first extraction submodule, configured to perform feature extraction on the image to be processed by use of a convolutional layer in a neural network to obtain the first feature map. Correspondingly, a preset parameter set includes a first hyper-parameter, a second hyper-parameter and a learning parameter. The first calculation module 502 includes a first calculation submodule, configured to calculate the final weight vector of the first feature map according to the first hyper-parameter, second hyper-parameter and learning parameter in the preset parameter set.

In the embodiment of the disclosure, the first calculation submodule includes: a first determination unit, configured to determine a preset constraint condition according to the first hyper-parameter and the second hyper-parameter; and a second determination unit, configured to determine the final weight vector of the first feature map according to the constraint condition and the learning parameter. The learning parameter is configured to calculate the final weight vector of the first feature map, the first hyper-parameter is configured to represent a center of a preset simplex and the second hyper-parameter is configured to reduce a value range of the final weight vector.

In the embodiment of the disclosure, the preset constraint condition is that a distance between the final weight vector and the first hyper-parameter is limited to be greater than or equal to a value of the second hyper-parameter.

In the embodiment of the disclosure, the first acquisition module 501 includes: a first determination submodule, configured to determine a mean vector and variance vector of the first feature map; and a second determination submodule, configured to determine a mean final weight vector corresponding to the mean vector and a variance final weight vector corresponding to the variance vector according to the preset constraint condition and the learning parameter respectively. Correspondingly, the first determination module 503 includes a third determination submodule, configured to correspondingly determine a first mean sub-normalization manner and a second variance sub-normalization manner according to the mean final weight vector and the variance final weight vector respectively, where the first sub-normalization manner and the second sub-normalization manner are the same or different. Correspondingly, the first processing module 504 includes a first normalization submodule, configured to correspondingly normalize the mean vector and the variance vector according to the first sub-normalization manner and the second sub-normalization manner to obtain a normalized mean vector and a normalized variance vector respectively; and a fourth determination submodule, configured to obtain the second feature map according to the normalized mean vector, the normalized variance vector and the first feature map.

In the embodiment of the disclosure, the first determination submodule includes a third determination unit, configured to determine the mean vector and variance vector of the first feature map based on the preset normalization set. Both a dimension of the mean vector and a dimension of the variance vector are the same as the number of normalization manners in the preset normalization set, a mean of the mean vector in the ith dimension corresponds to the jth normalization manner in the preset normalization set, a variance of the variance vector in the ith dimension corresponds to the jth normalization manner in the preset normalization set, and both i and j being integers greater than 0 and less than or equal to the number of the normalization manners in the preset normalization set.

In the embodiment of the disclosure, the device includes: a second determination module and a third determination module. The second determination module is configured to determine a dimension of the learning parameter, a dimension of the first hyper-parameter and a value of the first hyper-parameter in each dimension according to the number of the normalization manners in the preset normalization set. A sum of the values of the first hyper-parameter in each the dimension is 1, the dimension of the first hyper-parameter is the same as the dimension of the learning parameter, the value of the first hyper-parameter in each dimension is the same and the sum of the values in each dimension is 1. The third determination module is configured to determine a distance from the center to vertex of the preset simplex and determine the distance as a preset threshold corresponding to the second hyper-parameter. The preset simplex has a preset fixed value for each edge, and the number of vertexes thereof is the same as the number of the normalization manners, and the second hyper-parameter has a value greater than 0 and less than or equal to the preset threshold.

In the embodiment of the disclosure, the first calculation submodule includes: a fourth determination unit, configured to determine a first sub-weight vector according to the second hyper-parameter and the learning parameter; and a fifth determination unit, configured to determine the first sub-weight vector as the final weight vector if a distance between the first sub-weight vector and the first hyper-parameter is greater than or equal to the second hyper-parameter.

In the embodiment of the disclosure, the device further includes: a fourth determination module, configured to determine a second sub-weight vector according to the first hyper-parameter, the second hyper-parameter and the first sub-weight vector, if the distance between the first sub-weight vector and the first hyper-parameter is less than the second hyper-parameter; and a fifth determination module, configured to determine the second sub-weight vector as the final weight vector if the second sub-weight vector is greater than or equal to 0.

In the embodiment of the disclosure, the device further includes: a first updating module, configured to update the first hyper-parameter according to the second sub-weight vector to obtain an updated first hyper-parameter if the second sub-weight vector is less than 0; a sixth determination module, configured to determine an updated second hyper-parameter according to the second hyper-parameter, the updated first hyper-parameter and a first hyper-parameter that is not updated; a seventh determination module, configured to determine a third sub-weight vector according to the second sub-weight vector and the learning parameter; and an eighth determination module, configured to determine the final weight vector according to the updated first hyper-parameter, the updated second hyper-parameter and the third sub-weight vector.

In the embodiment of the disclosure, the first normalization submodule includes: a first calculation unit, configured to correspondingly multiply a weight of the mean final weight vector in each dimension and a weight of the mean vector in each dimension in a one-to-one correspondence, and add products obtained in each dimension to obtain the normalized mean vector; and a second calculation unit, configured to correspondingly multiply a weight in each dimension in the variance final weight vector and a variance of the variance vector in each dimension in a one-to-one correspondence and add products obtained in each dimension to obtain the normalized variance vector.

In the embodiment of the disclosure, the fourth determination submodule includes: a first difference calculation unit, configured to determine a difference between the first feature map and the normalized mean vector; a third calculation unit, configured to determine a mean variance corresponding to a sum of the normalized variance vector and a preset adjustment amount; a fourth calculation unit, configured to determine a ratio of the difference to the mean variance; a first scaling unit, configured to scale the ratio according to a preset scaling parameter to obtain a scaled ratio; and a first adjustment unit, configured to adjust the scaled ratio according to a preset shift parameter to obtain the second feature map.

It is to be noted that descriptions of the above device embodiments are similar to descriptions of the method embodiments and have beneficial effects similar to those of the method embodiments. Technical details undisclosed in the device embodiments of the disclosure may be understood with reference to the descriptions about the method embodiments of the disclosure.

It is to be noted that, in the embodiments of the disclosure, when being implemented in the form of software function modules and sold or used as an independent product, the image processing method may also be stored in a computer-readable storage medium. Based on such an understanding, the technical solutions of the embodiments of the disclosure substantially or parts making contributions to the conventional art may be embodied in the form of software product, and the computer software product is stored in a storage medium, including a plurality of instructions for enabling an instant messaging device (which may be a terminal and a server, etc.) to perform all or part of the method in each embodiment of the disclosure. The storage medium includes various media capable of storing program codes such as a U disk, a mobile hard disk, a Read Only Memory (ROM), a magnetic disk or an optical disk. As a consequence, the embodiments of the disclosure are not limited to any specific hardware and software combination.

Correspondingly, the embodiments of the disclosure provide a computer storage medium, which stores computer-executable instructions that, when being executed, cause to implement the steps of the image processing method provided in the embodiments of the disclosure.

The embodiments of the disclosure provide a computer device, which includes a memory and a processor. The memory is configured to store computer-executable instructions. The processor is configured to execute the computer-executable instructions in the memory to implement the steps in the image processing method provided in the embodiments of the disclosure.

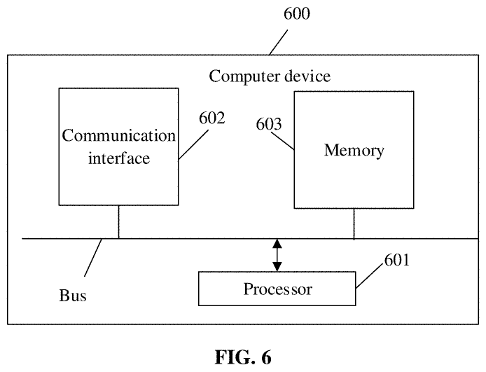

FIG. 6 is a composition structure diagram of a computer device according to an embodiment of the disclosure. As shown in FIG. 6, a hardware entity of the computer device 600 includes a processor 601, a communication interface 602 and a memory 603.

The processor 601 usually controls an overall operation of the computer device 600.

The communication interface 602 may enable the computer device to communicate with another terminal or server through a network.

The memory 603 is configured to store instructions and applications executable by the processor 601, or may also cache data (for example, image data, video data, voice communication data and video communication data) to be processed or having been processed by the processor 601 and each module in the computer device 600, or may be implemented through a flash or a Random Access Memory (RAM).

The above descriptions about the instant computer device and storage medium embodiments are similar to descriptions about the method embodiments and beneficial effects similar to those of the method embodiments are achieved. Technical details undisclosed in the instant communication device and storage medium embodiments of the disclosure may be understood with reference to the descriptions of the method embodiments of the disclosure.

It is to be understood that “one embodiment” and “an embodiment” mentioned in the whole specification mean that specific features, structures or characteristics related to the embodiment is included in at least one embodiment of the disclosure. Therefore, “in one embodiment” or “in an embodiment” appearing at any place of the whole specification does not always refer to the same embodiment. In addition, these specific features, structures or characteristics may be combined in one or more embodiments in any proper manner. It is to be understood that, in various embodiments of the disclosure, a magnitude of a sequence number of each process does not mean an execution sequence and the execution sequence of each process should be determined by its function and an internal logic, and should not form any limit to an implementation process of the embodiments of the disclosure. The sequence numbers of the embodiments of the disclosure are adopted not to represent superiority-inferiority of the embodiments but only for description.

It is to be noted that terms “include” and “comprise” or any other variant thereof are intended to cover nonexclusive inclusions herein, so that a process, method, object or device including a series of elements not only includes those elements but also includes other elements which are not clearly listed or further includes elements intrinsic to the process, the method, the object or the device. Without more limitations, an element defined by the statement “including a/an” does not exclude existence of the same other elements in a process, method, object or device including the element.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling, direct coupling or communication connection between various displayed or discussed components may be indirect coupling or communication connection, implemented through some interfaces, of the device or the units, and may be electrical and mechanical or adopt other forms.

The units described as separate parts may or may not be physically separated, and parts displayed as units may or may not be physical units, namely may be located in the same place, or may also be distributed to multiple network units. Part or all of the units may be selected according to a practical requirement to achieve the purposes of the solutions of the embodiments.

In addition, various functional units in each embodiment of the disclosure may be integrated into a processing unit, or serve as an independent unit, or and two or more units may also be integrated into a unit. The integrated unit may be implemented in a hardware form, or may be implemented in form of hardware and software functional unit.

Those of ordinary skill in the art should know that all or part of the steps of the method embodiments may be implemented by related hardware instructed by a program. The program may be stored in a computer-readable storage medium, and when being executed, implement the steps of the method embodiments. The storage medium includes: various media capable of storing program codes, such as a mobile storage device, a ROM, a magnetic disk or a compact disc.

Or, when being implemented in form of software functional module and sold or used as an independent product, the integrated unit of the disclosure may also be stored in a computer-readable storage medium. Based on such an understanding, the technical solutions of the embodiments of the disclosure substantially or parts making contributions to the conventional art may be embodied in the form of software product, and the computer software product is stored in a storage medium, including a plurality of instructions configured to enable a computer device (which may be a personal computer, a server or the like) to execute all or part of the method in various embodiments of the disclosure. The storage medium includes various media capable of storing program codes such as a mobile hard disk, a ROM, a magnetic disk or a compact disc.

The above is only the specific implementation mode of the disclosure and not intended to limit the scope of protection of the disclosure. Any modifications or substitutes apparent to those skilled in the art shall fall within the scope of protection of the disclosure. Therefore, the protection scope of the disclosure shall be subject to the scope of protection of the claims.

1. An image processing method, comprising:
acquiring a first feature map of an image to be processed;
determining a final weight vector of the first feature map;
determining a target normalization manner corresponding to the first feature map in a preset normalization set according to the final weight vector; and
performing normalization processing on the first feature map in the target normalization manner to obtain a second feature map.

2. The method of claim 1, wherein acquiring the first feature map of the image to be processed comprises:
performing feature extraction on the image to be processed by using a convolutional layer in a neural network to obtain the first feature map; and
wherein determining the final weight vector of the first feature map comprises:
calculating the final weight vector of the first feature map according to a first hyper-parameter, a second hyper-parameter and a learning parameter that are comprised in a preset parameter set.

3. The method of claim 2, wherein calculating the final weight vector of the first feature map according to the first hyper-parameter, second hyper-parameter and learning parameter in the preset parameter set comprises:
determining a preset constraint condition according to the first hyper-parameter and the second hyper-parameter; and
determining the final weight vector of the first feature map according to the preset constraint condition and the learning parameter, wherein the learning parameter is configured to calculate the final weight vector of the first feature map, the first hyper-parameter is configured to represent a center of a preset simplex and the second hyper-parameter is configured to reduce a value range of the final weight vector.

4. The method of claim 3, wherein the preset constraint condition is that a distance between the final weight vector and the first hyper-parameter is limited to be greater than or equal to a value of the second hyper-parameter.

5. The method of claim 1, wherein determining the final weight vector of the first feature map comprises: determining a mean vector and variance vector of the first feature map, and determining, according to a preset constraint condition and a learning parameter, a mean final weight vector corresponding to the mean vector and a variance final weight vector corresponding to the variance vector respectively;
wherein determining the target normalization manner corresponding to the first feature map in the preset normalization set according to the final weight vector comprises: correspondingly determining a first mean sub-normalization manner and a second variance sub-normalization manner according to the mean final weight vector and the variance final weight vector respectively, wherein the first mean sub-normalization manner and the second variance sub-normalization manner are the same or different; and
wherein performing normalization processing on the first feature map in the target normalization manner to obtain the second feature map comprises: correspondingly normalizing the mean vector and the variance vector according to the first mean sub-normalization manner and the second variance sub-normalization manner to obtain a normalized mean vector and a normalized variance vector; and obtaining the second feature map according to the normalized mean vector, the normalized variance vector and the first feature map.

6. The method of claim 5, wherein determining the mean vector and variance vector of the first feature map comprises:
determining the mean vector and variance vector of the first feature map based on the preset normalization set,
wherein a dimension of the mean vector and a dimension of the variance vector are the same as a number of normalization manners in the preset normalization set,
wherein a mean of the mean vector in an i-th dimension correspond to a j-th normalization manner in the preset normalization set, a variance of the variance vector in the i-th dimension correspond to the j-th normalization manner in the preset normalization set, i and j being integers greater than 0 and less than or equal to the number of the normalization manners in the preset normalization set.

7. The method of claim 2, comprising:
determining a dimension of the learning parameter, a dimension of the first hyper-parameter and a value of the first hyper-parameter in each dimension according to a number of normalization manners in the preset normalization set, wherein a sum of values of the first hyper-parameter in each dimension is 1, the dimension of the first hyper-parameter is the same as the dimension of the learning parameter, and the first hyper-parameter has the same value in each dimension; and
determining a distance from a center to a vertex of a preset simplex, and determining the distance as a preset threshold corresponding to the second hyper-parameter, wherein the preset simplex has a preset fixed value for each edge and a number of vertexes thereof is the same as the number of normalization manners, and the second hyper-parameter has a value greater than 0 and less than or equal to the preset threshold.

8. The method of claim 2, wherein calculating the final weight vector of the first feature map according to the first hyper-parameter, second hyper-parameter and learning parameter in the preset parameter set comprises:
determining a first sub-weight vector according to the second hyper-parameter and the learning parameter; and
determining the first sub-weight vector as the final weight vector if a distance between the first sub-weight vector and the first hyper-parameter is greater than or equal to the second hyper-parameter.

9. The method of claim 8, wherein after determining the first sub-weight vector according to the second hyper-parameter and the learning parameter, the method further comprises:
determining a second sub-weight vector according to the first hyper-parameter, the second hyper-parameter and the first sub-weight vector if the distance between the first sub-weight vector and the first hyper-parameter is less than the second hyper-parameter; and
determining the second sub-weight vector as the final weight vector if the second sub-weight vector is greater than or equal to 0.

10. The method of claim 9, wherein after determining the second sub-weight vector according to the first hyper-parameter, the second hyper-parameter and the first sub-weight vector, the method further comprises:
updating the first hyper-parameter according to the second sub-weight vector to obtain an updated first hyper-parameter, if the second sub-weight vector is less than zero;
determining an updated second hyper-parameter according to the second hyper-parameter, the updated first hyper-parameter and a first hyper-parameter that is not updated;
determining a third sub-weight vector according to the second sub-weight vector and the learning parameter; and
determining the final weight vector according to the updated first hyper-parameter, the updated second hyper-parameter and the third sub-weight vector.

11. The method of claim 5, wherein correspondingly normalizing the mean vector and the variance vector according to the first mean sub-normalization manner and the second variance sub-normalization manner to obtain the normalized mean vector and the normalized variance vector respectively comprises:
multiplying a weight of the mean final weight vector in each dimension and a weight of the mean vector in each dimension in a one-to-one correspondence manner, and adding products obtained in each dimension to obtain the normalized mean vector; and
multiplying a weight of the variance final weight vector in each dimension and a variance of the variance vector in each dimension in a one-to-one correspondence manner, and adding products obtained in each dimension to obtain the normalized variance vector.

12. The method of claim 5, wherein obtaining the second feature map according to the normalized mean vector, the normalized variance vector and the first feature map comprises:
determining a difference between the first feature map and the normalized mean vector;
determining a mean variance corresponding to a sum of the normalized variance vector and a preset adjustment amount;
determining a ratio of the difference to the mean variance;
scaling the ratio according to a preset scaling parameter to obtain a scaled ratio; and
adjusting the scaled ratio according to a preset shift parameter to obtain the second feature map.

13. An image processing device, comprising: a processor; and a memory for storing instructions executable by the processor, wherein the processor is configured to:
acquire a first feature map of an image to be processed;
determine a final weight vector of the first feature map;
determine a target normalization manner corresponding to the first feature map in a preset normalization set according to the final weight vector; and
perform normalization processing on the first feature map in the target normalization manner to obtain a second feature map.

14. The device of claim 13, wherein the processor is configured to acquire the first feature map of the image to be processed by:
performing feature extraction on the image to be processed by using a convolutional layer in a neural network to obtain the first feature map; and
the processor is configured to determine the final weight vector of the first feature map by:
calculating the final weight vector of the first feature map according to a first hyper-parameter, a second hyper-parameter and a learning parameter that are comprised in a preset parameter set.

15. The device of claim 14, wherein the operation of calculating the final weight vector of the first feature map according to the first hyper-parameter, the second hyper-parameter and the learning parameter in the preset parameter set comprises:
determining a preset constraint condition according to the first hyper-parameter and the second hyper-parameter; and
determining the final weight vector of the first feature map according to the preset constraint condition and the learning parameter, wherein the learning parameter is configured to calculate the final weight vector of the first feature map, the first hyper-parameter is configured to represent a center of a preset simplex and the second hyper-parameter is configured to reduce a value range of the final weight vector.

16. The device of claim 15, wherein the preset constraint condition is that a distance between the final weight vector and the first hyper-parameter is limited to be greater than or equal to a value of the second hyper-parameter.

17. The device of claim 13, wherein the processor is configured to determine the final weight vector of the first feature map by: determining a mean vector and variance vector of the first feature map, and determining, according to a preset constraint condition and a learning parameter, a mean final weight vector corresponding to the mean vector and a variance final weight vector corresponding to the variance vector respectively;
wherein the processor is configured to determine the target normalization manner corresponding to the first feature map in the preset normalization set according to the final weight vector by: correspondingly determining a first mean sub-normalization manner and a second variance sub-normalization manner according to the mean final weight vector and the variance final weight vector respectively, wherein the first mean sub-normalization manner and the second variance sub-normalization manner are the same or different; and
wherein the processor is configured to perform normalization processing on the first feature map in the target normalization manner to obtain the second feature map by: correspondingly normalize the mean vector and the variance vector according to the first mean sub-normalization manner and the second variance sub-normalization manner to obtain a normalized mean vector and a normalized variance vector respectively, and obtaining the second feature map according to the normalized mean vector, the normalized variance vector and the first feature map.

18. The device of claim 17, wherein the operation of determining the mean vector and variance vector of the first feature map comprises:
determining the mean vector and variance vector of the first feature map based on the preset normalization set,
wherein a dimension of the mean vector and a dimension of the variance vector are the same as a number of normalization manners in the preset normalization set,
wherein a mean of the mean vector in an i-th dimension correspond to a j-th normalization manner in the preset normalization set, a variance of the variance vector in the i-th dimension correspond to the j-th normalization manner in the preset normalization set, i and j being integers greater than 0 and less than or equal to the number of the normalization manners in the preset normalization set.

19. The device of claim 14, wherein the processor is further configured to:
determine a dimensionality of the learning parameter, a dimension of the first hyper-parameter and a value of the first hyper-parameter in each dimension according to a number of normalization manners in the preset normalization set, wherein a sum of values of the first hyper-parameter in each dimension is 1, the dimension of the first hyper-parameter is the same as the dimension of the learning parameter, and the first hyper-parameter has the same value in each dimension; and
determine a distance from a center to a vertex of a preset simplex and determine the distance as a preset threshold corresponding to the second hyper-parameter, wherein the preset simplex has a preset fixed value for each edge and a number of vertexes thereof is the same as the number of normalization manners, and the second hyper-parameter has a value greater than 0 and less than or equal to the preset threshold.

20. A non-transitory computer storage medium, having stored therein computer-executable instructions that, when being executed, enable to implement steps of an imaging processing method, comprising:
acquiring a first feature map of an image to be processed;
determining a final weight vector of the first feature map;
determining a target normalization manner corresponding to the first feature map in a preset normalization set according to the final weight vector; and
performing normalization processing on the first feature map in the target normalization manner to obtain a second feature map.
